(19) United States
(12) Patent Application Publication
(10) Pub. No.: US 2010/0310826 A1
(43) Pub. Date: Dec. 9, 2010

(54) WOOD STAIN APPEARANCE ON A NON-WOOD SUBSTRATE

(75) Inventors: William M. Miles, Blacklick, OH (US); Wallace L. Kesler, Burnsville, MN (US); Gregory L. Wascomb, Pickerington, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 12/779,319

(22) Filed: May 13, 2010

Related U.S. Application Data
(60) Provisional application No. 61/177,790, filed on May 13, 2009.

(51) Int. Cl. B44F 9/02; B44C 1/22; E04C 2/30; B32B 3/00

(52) U.S. Cl. 428/151; 216/29

(57) ABSTRACT

This invention is directed to a process of creating a wood stained appearance on a non-wood textured substrate, and a non-wood product utilizing the method to create a realistic wood-stained substrate. The process comprises application of a pigmented alkaline-soluble water based glaze colored match the contrasting grain-like recesses in a textured substrate. After drying, the glazed surface peaks are solubilized and wiped using an alkaline solution to leave only the grain-like recesses coated with contrasting pigmented glaze.

This application claims priority to and the benefit of U.S. Application Ser. No. 61/177,790, filed on May 13, 2009, of which the entire disclosure (including any and all figures) is incorporated herein by reference.

This invention is directed to a process of creating a wood stained appearance on a non-wood textured substrate, and a non-wood product utilizing the method to create a realistic wood-stained substrate. A large variety of textured non-wood surfaces, such as resin, composite, steel, vinyl, hardboard, sheet molded compound (SMC) may be coated using the process of this invention to produce a surface having a stained wood “wood-grained” effect. Some examples include molded doors, windows and other wood-simulating panels, various extruded and injection molded articles for the building industry, including decking materials such as boards, end-caps, railing, cabinets, siding, fencing, flooring tiles, spindles, posts, and the like which have one or more surfaces textured to simulate the regular grain patterns associated with any of a variety of types of wood.

In U.S. Pat. No. 5,534,352, Pittman, et al., describe a process for pre-finishing wood composite panels and/or structures having flat and contoured surfaces to result in a structure exhibiting the appearance of natural hard wood. The process includes a number of steps designed to facilitate industrial scale, machine production. To that end, they employ a ground coat in a first step, then a non-adherent “dry buffing glaze” which is selectively removed, and finally they apply a sealer to retain the remaining buffing glaze in textured ticks of the substrate. The dry buffing glaze is preferably a waterborne coating, applied to the substrate as a liquid and then flash dried to yield a dull powdery appearance. The true color of the glaze is not evident until it is wetted in a subsequent toning or top-coating step. The glaze has a high proportion (e.g., at least about 80 weight %) of inert pigments so as to make it powdery and easily buffed from flat surfaces of the substrate. This type of powdery buffing composition has no bonding capability to the base and tends to provide a plane of weakness where the ultimate glazed finish can easily separate. When separated, the finish is irreparably discolored in the area of the separation. The use of a clear glaze is necessary for protection of the color, but is highly susceptible to ultraviolet light damage. Clear finishes of this type rapidly yellow and lose their initial physical strength.

Prior art procedures to create wood grained effect on textured non-wood entry doors or other textured surfaces is to apply the second step (glaze) as a solvent based product then removing excess glaze from peaks while wet by wiping, sponging, or brushing to leave the wood grained effect.

### BRIEF DESCRIPTION OF THE DRAWINGS

It will be appreciated that the illustrated boundaries of elements (e.g., boxes or groups of boxes) in the figures represent one example of the boundaries. One of ordinary skill in the art will appreciate that one element may be designed as multiple elements or that multiple elements may be designed as one element. An element shown as an internal component of another element may be implemented as an external component and vice versa.

Further, in the accompanying drawings and description that follow, like parts are indicated throughout the drawings and description with the same reference numerals, respectively. The figures are not drawn to scale and the proportions of certain parts have been exaggerated for convenience of illustration.

FIG. 1 illustrates individual sheet molded wood grained door panels after each individual step of the process of the invention, from the step 1 blank, step 2 with a base coat, step 3 with the removable glaze over the basecoat, and step 4, after the excess glaze is removed with alkaline solution to reveal the contrasting wood grain.

FIG. 2 illustrates sequential process steps of this invention demonstrated on a single sheet molded wood grained door panel.

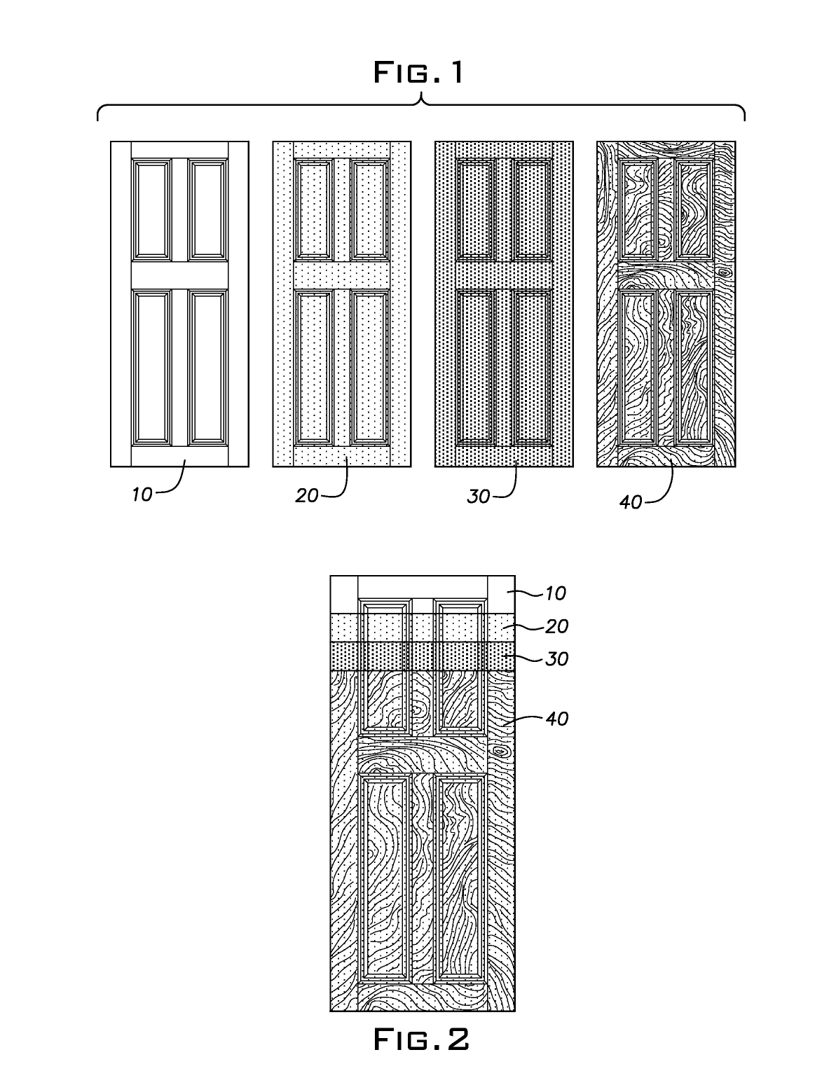

### DESCRIPTION OF THE INVENTION

The process of this invention utilizing appropriate color combinations of a base coat and an accompanying glaze provides resulting molded doors, windows and other wood-simulating panels, etc., which more closely resembles real wood-stained products.

The process of this invention has particular advantage in applying a wood-grained appearance to a grain-textured substrate. The invention has particular advantage for imparting a realistic wood-grain appearance to molded doors, windows, trim and other wood-simulating panels, composites or components, interior molding components, etc., which have three-dimensional wood grain surfaces textured to simulate the regular grain patterns associated with any of a variety of types of wood.

The process for producing the stained wood appearance in accordance with this invention comprises a first step of applying a suitable pigmented or unpigmented basecoat to a textured wood grain substrate, the base coat being the undertone color of the desired wood grained pattern. The second step is the application of an alkaline-soluble water based glaze pigmented to match the contrasting grain-like recesses (observed as valleys in textured substrate). After drying, the glazed surface peaks are solubilized and wiped using an alkaline solution to leave only the grain-like recesses coated with contrasting pigmented glaze. The final step is application of suitable clear topcoat to protect underlying system and produce the desired gloss of finished product.

According to this invention, a basecoat composition is applied by spray or brush. The basecoat can be a pigmented or unpigmented waterborne or solventborne crosslinkable composition useful in coatings applications (such as those having resinous binders of acrylic polymers, polyethers, polyesters, including alkyds, and polyurethanes), so long as the resin is resistant to the alkaline removing compound. The basecoat can be applied to a dry film thickness of from 0.5 to 2.5 mils, depending on the depth of the profile of the substrate. It is important that the basecoat possess strong adhesion to the many varieties of substrates to be coated such as: primed steel doors, fiberglass doors, kitchen cabinets, wood doors and composite doors. Basecoat formulations should provide adhesion to the many types of door glass moldings comprised of acrylic, polyvinyl chloride (PVC), styrene, and more. Furthermore, the basecoat should have flow and leveling to obtain uniform coverage on the surface of any substrate with a simulated wood grain and suitable resistance to alkalinity. The coverage should ensure adhesion to adequate coating dry mil thickness on the entire surface of the door for opacity and effective two-step application process, and to ensure longevity, and durability of the coating. Suitable commercially available basecoats for this invention include Sherwin-Williams' KemAqua® enamel, Kem® 400 Enamel, Polane G, Polane S, Polane 2k water, and Sher-Wood® Pigmented Lacquer. After application, the basecoat is allowed to flash thoroughly and dry completely and if necessary, the basecoat can be baked to expedite processing.

The glaze of this invention is an alkaline-soluble pigmented waterborne acrylic composition; that is, the resin of the glaze has functionality that imparts alkaline solubility. A composition useful for the glaze of this invention comprises: from about 4.0 to about 70% of a suitable alkaline soluble resin, from 0.1 to 5% surfactants, 0.1 to 3% thickeners, 4 to 80% water, 1 to 10% solvents and 1 to 3% dispersants, these materials being combined and formulated in accordance with procedures known to the art. Sample ranges are illustrated in the example, and can vary based on application, and can be modified by up to 50% of the indicated amounts. A higher resin content may affect removability of the glaze. Pigments used in the glaze composition can range from 4 to 25% by weight total pigment. The glaze is applied onto the substrate in an amount sufficient to provide contrasting color to texture recesses as in real wood grain in the substrate. Applicators such as a cloth, brush, squeegee, sponge or combinations of these, can be used. Spray methods can also be used. The glaze can be applied at a wet film thickness of about 1 mil to about 5 mils, or as desired to give desired grain-look results. After application of the glaze composition, drying can be done by air or assisted with heat. The glaze coat is allowed to dry before wiping with an alkaline wiping solution.

The colors utilized for the basecoat and glaze coat are compatibly selected to provide a natural look of any selected wood type, e.g., oak, maple, cherry, walnut, pine, and the like. The pigments can be any of those typically used in similar compositions, such as raw umber, burnt umber, raw sienna, titanium dioxide, yellow oxides, black, red oxides, rutile titanium, various blends of these with other colored pigments and dyes.

The combined use of the basecoat with a glaze coat as provided by the invention provides a brilliance and depth of natural wood simulation that is distinctly different than achieved by prior art methods. The brilliance is attributed to the provision of the contrasting glaze color filling the textured recesses and then the glaze is selectively solubilized and wiped from only the raised surfaces of the substrate with an alkaline solution after the glaze has dried. The alkaline solution can be an ammonia/water solution, or any alkaline solution capable of solubilizing the dried glaze coat. For example, a 0.5% ammonia in water solution can be useful, 0.1-0.9% sodium hydroxide, commercial floor wax strippers, or Sprayon® Mop 'N Melt™ or Impact™ floor strippers can be useful, depending on the application.

Following the wiping with alkaline solution, any protective water-reducible top coat or solvent-based topcoat, depending on the application or use, can be applied. Examples of commercially available topcoats for interior and exterior use include Sherwin-Williams' Polane® polyurethanes such as Polane® S and Polane® S Plus, Krylon® SparVar® lacquer and SherWood® BP Enamel clear, to name a few. The topcoat may contain conventional additives such as UV protectors. Such additives are particularly desirable for exterior grade doors. It is preferable to apply multiple topcoats so as to achieve a durable, protective layer, at a minimum of 2 mils dry film thickness.

### Example 1

A sheet molded compound exterior door panel is coated with the basecoat composition and a glaze coat utilizing the glaze resin of Table I. A pigmented basecoat coating composition such as commercially available Sherwin-Williams KEM Aqua is applied by spraying on the door panel to achieve a non-running, even, uniform coat.

TABLE I
GLAZE FORMULATION

| | Weight Percent |
|---|---|
| Ingredient | (Wt %) |
| Alkaline-soluble 100% Acrylic resin | 56.2 |
| Tego Foamex 805 Defoamer | 1.0 |
| Surfynol 104DPM surfactant | 0.25 |
| Propylene Glycol | 1.54 |
| DPBC-20 mildewcide | 0.65 |
| Tinuvin 1130 UV Absorber | 0.58 |
| 292 UV Stabilizer | 0.25 |
| Water | 38.7 |
| Acrysol Rm-SW | 0.89 |

To simulate a red mahogany, the glaze resin of Table I is utilized in the following formulation in Table II:

TABLE II
RED MAHOGANY GLAZE FORMULATION

| | Weight Percent |
|---|---|
| Ingredient | (Wt %) |
| Glaze Resin of Table I | 41.06 |
| Water | 53.41 |
| Aqueous Carbon Black Pigment Dispersion | 0.98 |
| 0 VOC Red Oxide Pigment Dispersion | 1.15 |
| 0 VOC Quindo Violet Pigment Dispersion | 0.52 |
| Glycerine 96% | 2.83 |

Other pigments can be selected to likewise simulate other wood types, such as oak, cherry, birch, etc.

The red mahogany glaze coating of Table II is applied by HVLP spray equipment, supply set at 10 psi max and pot pressure at 2-4 psi. For best results, glaze is delivered in large droplets gently to the surface to increase working time. The glaze can be spread evenly across the grain with bristle brushes, foam brushes, rags or any combination of these to achieve the desired graining effect. The glaze is dried, with heat if necessary. The glaze of the coated door panel is then selectively solubilized and wiped with a cloth containing the alkaline glaze wiping solution to remove the glaze from the surface outside the grain pattern, working across the grain pattern. The major advantage of the process is the ability to selectively remove the glaze in case of excess or in case of any imperfections that may arise during handling, or for aesthetic appeal, etc. Water-based systems are typically are fast dry and do not allow enough time to wipe, sponge or brush off peaks. The panel is dried after removal of the glaze, heat drying, if necessary. Polane 2K Water Reducible Urethane Clear is applied as a topcoat. Clear coat should flash for 10 minutes before baking 15 minutes at 120° F.

What is claimed is:

1. A process for producing a wood stained effect comprising:
a. a first step of applying a suitable pigmented basecoat to a textured non-wood wood grain substrate, wherein the substrate has a raised upper surface and grain-like recesses;
b. allowing the basecoat to dry;
c. applying a pigmented alkaline-soluble water-based glaze coating over the basecoat, the glaze coating pigmented to match a contrasting wood grain in an amount sufficient to provide a contrasting color to the grain-like recesses of the wood grain substrate;
d. allowing the glaze coating to dry; and
e. selectively removing the dried glaze coating from the raised upper surface by wiping the glazed raised surface with an alkaline solution, wherein the glaze in the grain-like recesses is retained.

2. The process of claim 1, further comprising applying a topcoat over the glazed surface.

3. The process according to claim 1 wherein one or more of said applying steps may be selected from the steps consisting of spraying, brushing, rollering, wiping, sponging, or a combination thereof.

4. The process of claim 1, wherein a final product formed of the substrate is selected from the group consisting of entry doors, windows, various extruded and injection molded articles for the building industry, including decking materials such as boards, end-caps, railing, cabinets, siding, fencing, flooring tiles, spindles, posts, and the like.

5. The process of claim 1, wherein the substrate is made of a material selected from resin, composite, steel, vinyl, hardboard, sheet moulded compound (SMC) and recycled matter.

6. A product produced from the process of claim 1.
